(19) United States
(12) Patent Application Publication
(10) Pub. No.: US 2004/0015741 A1
(43) Pub. Date: Jan. 22, 2004

(54) Watchdog device operation

(75) Inventors: Noam Ben-Moyal, Petael Tikva (IL); Mor Moshe, Hodd Iasharon (IL); Lior Avital, Kfar Saba (IL); Amir Sharon, Ramat Hasharon (IL)

Correspondence Address: FOGG AND ASSOCIATES, LLC, P.O. BOX 581339, MINNEAPOLIS, MN, 55458-1339, US

(73) Assignee: ADC Telecommunications Israel Ltd.

(21) Appl. No.: 10/196,781

(22) Filed: Jul. 17, 2002

(51) Int. Cl. H04B 1/74; H02H 3/05

(52) U.S. Cl. 714/38

(57) ABSTRACT

A watchdog device is refreshed using either a hardware strobe or a software output as the refresh strobe. The hardware strobe is selected when the software output is undesirable as the refresh strobe. Undesirability includes the inability of the software output to reliably refresh the watchdog device or an unknown ability of the software output to reliably refresh the watchdog device.

### TECHNICAL FIELD OF THE INVENTION

The present invention relates generally to operation of processors utilizing a watchdog device for reset of a timeout condition, and in particular to selectively providing a hardware strobe as the refresh strobe during operation of software having an unknown refresh strobe period or a refresh strobe period likely to incorrectly indicate a timeout condition.

### BACKGROUND OF THE INVENTION

Processor-based devices occasionally become unstable, i.e., they can lock up, hang or crash. This instability is often the result of the software running on the processor entering an infinite loop. To exit such a loop, it is generally necessary to reset the processor. In many cases, this means rebooting the device. However, it is often desirable to automatically reset the device without the need for manual recognition and intervention. One method of providing this automatic reset behavior is through the use of a watchdog timer.

A watchdog timer operates in response to a refresh strobe generated by the software application. If the refresh strobe is not received by the watchdog timer prior to the expiration of its timeout, the watchdog timer initiates a reset of the processor. Software appropriate for use with a watchdog timer must generate the refresh strobe with a period less than the timeout of the watchdog timer. If the refresh strobe is not issued by the software application in the allotted time, it is presumed to be operating abnormally, thus justifying the reset of the processor. Unfortunately, many software applications do not generate the refresh strobe and must be specifically modified to do so. Some may issue a refresh strobe, but its period may exceed the timeout period of the watchdog timer or its period may simply be unknown, thus making it unworkable or unreliable for use with the watchdog timer. Appropriate modification of the software may not be possible without purchasing the source code.

For the reasons stated above, and for other reasons stated below that will become apparent to those skilled in the art upon reading and understanding the present specification, there is a need in the art for alternatives for operating software applications having an absent, unknown or unacceptable refresh strobe.

### SUMMARY

Watchdog devices are commonly utilized to reset a processor when software applications running on that processor fail, crash or otherwise experience abnormal behavior. As traditionally utilized, the software application is adapted to generate an output at a regular interval during normal operation, generally referred to as a refresh strobe. If the watchdog device does not receive the refresh strobe prior to a timeout of the watchdog device, it is presumed that the software application is experiencing abnormal behavior and a reset signal or other interrupt will be sent to the processor to cease operation of the software application and reset the processor. However, some software applications may not be adapted to generate the refresh strobe. Others may be adapted to generate a refresh strobe, but its period may exceed the timeout of the watchdog device or may simply be unknown to the user such that it may not be relied upon to operate the watchdog device reliably. The various embodiments allow for operation of software applications in systems having a watchdog device, whether or not the software applications are known to produce an acceptable refresh strobe. Such operation is facilitated by selecting either the software output or a hardware strobe to be used as the refresh strobe to the watchdog device. For software applications having a known acceptable refresh strobe, the software output can be provided to the watchdog device as the refresh strobe. For software applications having an unknown refresh strobe, or the absence of a refresh strobe, a hardware strobe can be provided to the watchdog device.

The embodiments of the invention allow the user to utilize software applications on their watchdog-controlled processor-based system regardless of whether the software applications are capable of producing a desirable refresh strobe. While the software applications may generally be modified to produce a desirable strobe, this can often require a significant investment in programming and verification to assure correct functionality. In addition, program modification typically requires that the user purchase the source code rather than the less costly compiled or library code. The invention includes methods and apparatus varying scope.

### BRIEF DESCRIPTION OF THE DRAWINGS

FIG. 1 is a typical electronic system having a watchdog device.

FIG. 2 is an electronic system having a watchdog device in accordance with an embodiment of the invention.

FIG. 3 is an electronic system having a watchdog device in accordance with another embodiment of the invention.

FIG. 4 is a flowchart showing one method of operating a watchdog device in accordance with an embodiment of the invention.

FIG. 5 is a flowchart showing one method of operating a watchdog device in accordance with another embodiment of the invention.

FIG. 6 is one example of a state diagram for use with methods of operating a watchdog device in accordance with embodiments of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, electrical or mechanical changes may be made without departing from the scope of the present invention. The following detailed description is, therefore, not to be taken in a limiting sense, and the scope of the present invention is defined only by the appended claims and equivalents thereof.

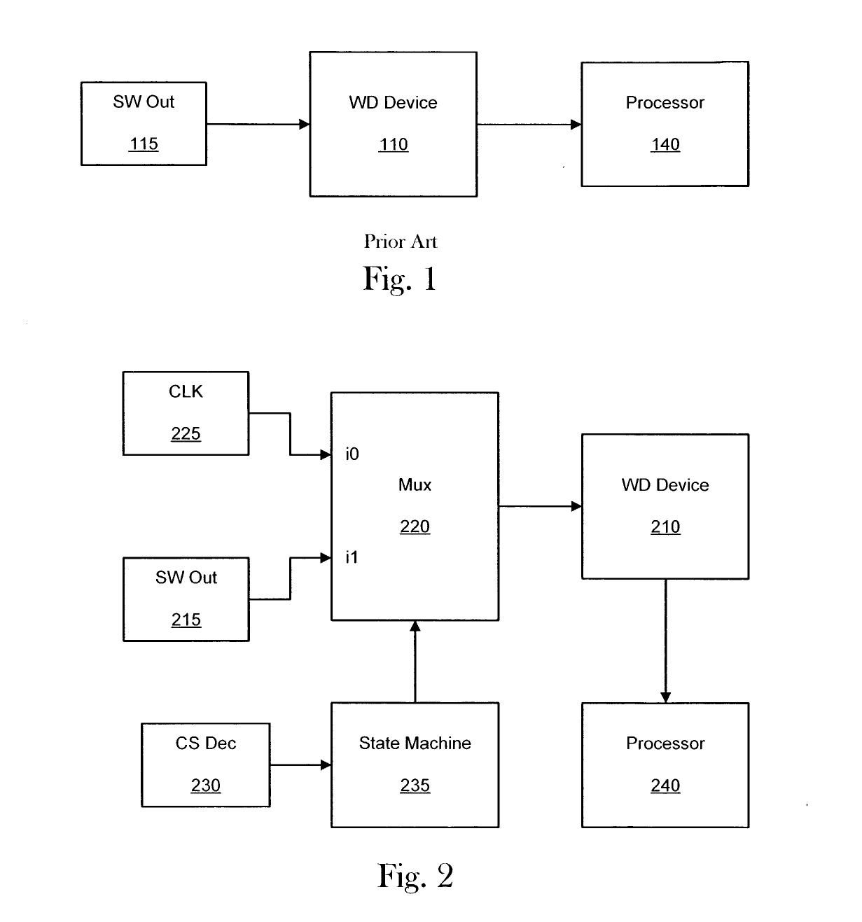

FIG. 1 is a typical electronic, or processor-based, system having a watchdog device. A watchdog device 110 receives a software output 115 as a refresh strobe. The software output 115 is an output of a software application running on the processor 140. If the refresh strobe is not received before a timeout period of the watchdog device 110, a reset signal is sent to the processor 140 to cause it to reset, thus ceasing operation of the software application. Such a reset will typically cause the processor to reboot, which may include restarting the software application, starting some other default operation, or placing the processor in an idle state.

FIG. 2 is an electronic, or processor-based, system having a watchdog device in accordance with an embodiment of the invention. A hardware strobe, e.g., a clock signal, 225 is provided to a first input of a multiplexer 220. The hardware strobe 225 has a period that is shorter than a timeout period of the watchdog device 210. As such, providing the hardware strobe 225 will keep the watchdog device 210 from causing a reset of the processor 240. A software output 215 is provided to a second input of the multiplexer 220. The software output 215 is an output of a software application running on the processor 240, which may include a regular strobe having an unknown period, a regular strobe having a period known to be longer than the timeout period of the watchdog device 210, an irregular strobe, some other strobe that is otherwise undesirable as a refresh strobe, or even the absence of a strobe.

The multiplexer 220 is responsive to a select signal to select either the hardware strobe 225 or the software output 215 to be provided on an output as the refresh strobe to the watchdog device 210. The select signal may be provided by a state machine 235 responsive to one or more control signals, such as a chip select signal from a chip select decoder 230. For one embodiment, the state machine 235 is adapted to generate the select signal having a first value to provide the refresh strobe from a software application to the watchdog device 210 during operation of the software application on the processor 240 if the software application is expected to generate a refresh strobe having a period of less than a timeout period of the watchdog device 210. Similarly, for this embodiment, the state machine 235 is adapted to generate the select signal having a second value to provide the hardware strobe 225 to the watchdog device 210 as a refresh strobe during operation of the software application on the processor 240 if the software application is not expected to generate a refresh strobe having a period of less than the timeout period of the watchdog device 210.

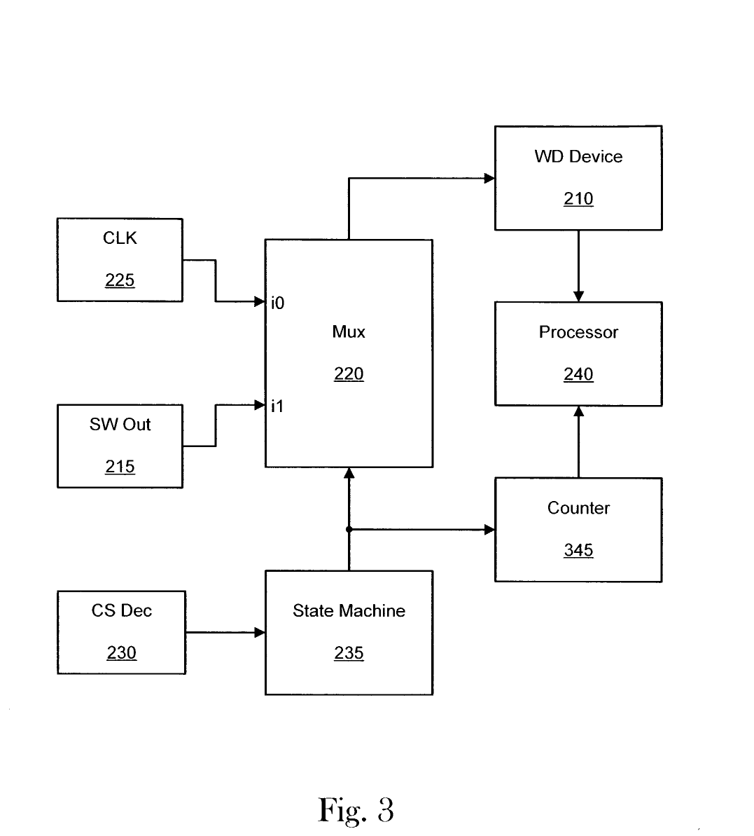

FIG. 3 is an electronic, or processor-based, system having a watchdog device in accordance with another embodiment of the invention. The system of FIG. 3 contains many of the same elements as FIG. 2. These common elements will not be repeated here. The system of FIG. 3 differs in the addition of a counter 345.

In providing the hardware strobe 225 to the watchdog device 210, there is no indication whether the software application is operating normally. To avoid missing detection of abnormal behavior, the software application may be allowed to run for a predetermined period of time before forcing a reset of the processor 240. For one embodiment, a counter 345 is initiated in response to an indication to use the hardware strobe 225 as the refresh strobe. The counter 345 then begins counting while the software application is running. If the counter 345 reaches a predetermined limit value corresponding to the predetermined period of time, the counter will issue the reset signal to the processor 240 despite the fact that the watchdog device 210 will not have timed out. The counter 345 is disabled in response to an indication to use the software output 215 as the refresh strobe. For one embodiment, disabling the counter 345 resets the counter 345. For another embodiment, initializing the counter 345 resets the counter 345.

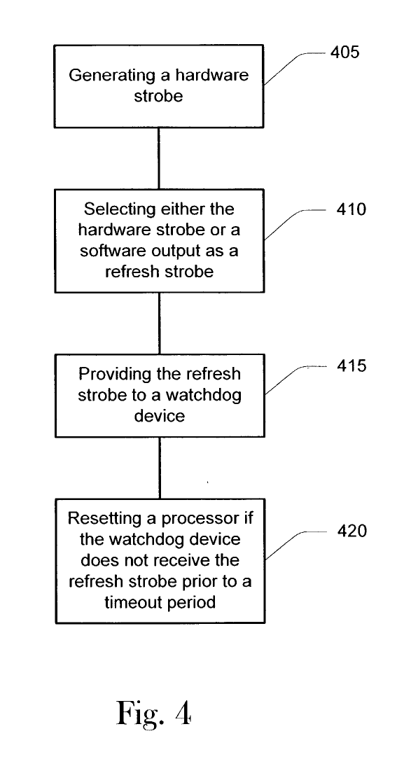

FIG. 4 is a flowchart showing one method of operating a watchdog device in accordance with an embodiment of the invention. A hardware strobe, such as a clock signal, is generated at 405. A selection of the hardware strobe or a software output as the refresh strobe occurs at 410. The selected refresh strobe is then provided to the watchdog device at 415. The associated processor is reset at 420 if the watchdog device does not receive the refresh strobe prior to a timeout period.

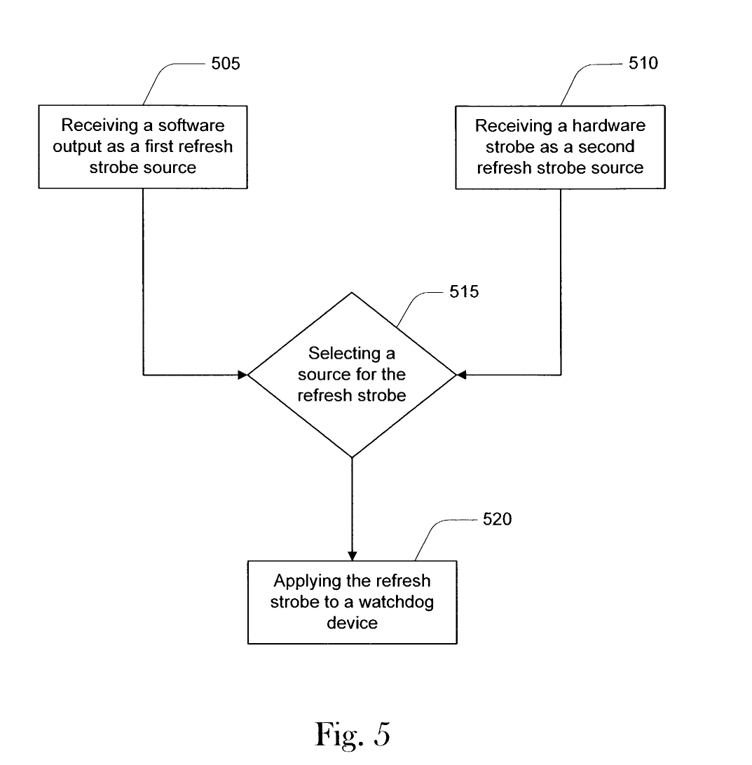

FIG. 5 is a flowchart showing one method of operating a watchdog device in accordance with another embodiment of the invention. A software output is received as a first refresh strobe source at 505. The software output may include a regular strobe having an unknown period, a regular strobe having a period known to be longer than the timeout period of the watchdog device, an irregular strobe, some other strobe that is otherwise undesirable as a refresh strobe, or even the absence of a strobe. A hardware strobe is received as a second refresh strobe source at 510. The hardware strobe may be any strobe independent of the software application and having a period of less than the timeout period of the watchdog device.

A strobe source is selected at 515. In general, the strobe source is selected as the hardware strobe when the software output is undesirable as the refresh strobe. Undesirability includes the inability of the software output to reliably refresh the watchdog device or an unknown ability of the software output to reliably refresh the watchdog device. The selected refresh strobe is then applied to the watchdog device at 520 for refreshing the watchdog device.

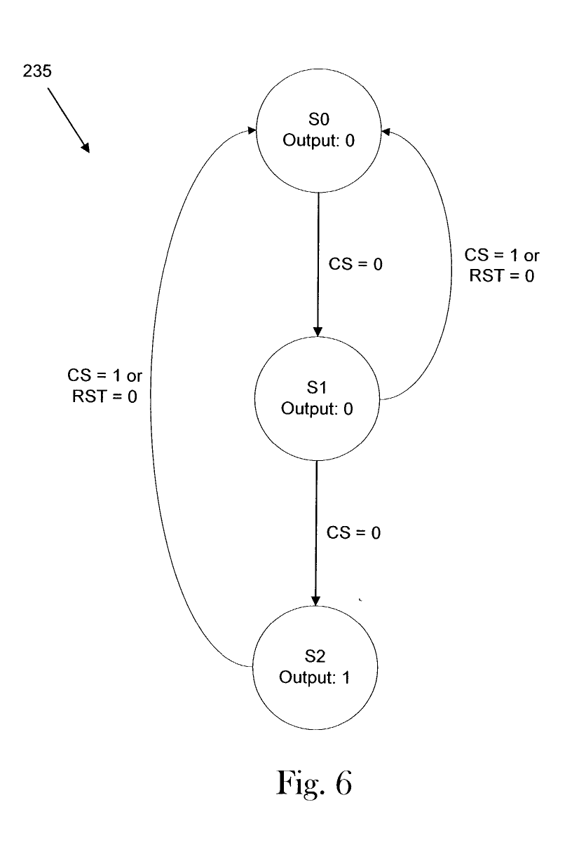

While a select signal may be generated to select between the hardware strobe and the software output at the same time the software application is started on the processor, it may be desirable to delay any selection of the software output as the refresh strobe for system stability or other reasons. A state machine can be used facilitate this delay. FIG. 6 is one example of a state diagram for use with methods of operating a watchdog device in accordance with embodiments of the invention.

The state machine 235 has a first state, S0, having a first output value, e.g., 0. The state machine 235 has a second state, S1, having the first output value. The state machine 235 further has a third state, S2, having a second output value, e.g., 1. The first output value corresponds to a selection of the hardware strobe as the refresh strobe while the second output value corresponds to a selection of the software output as the refresh strobe. The state machine 235 begins at the first state upon a reset of the processor in response to a first control signal, e.g., a reset signal (RST), having a first value, e.g., 0. The reset signal normally has a second value, e.g., 1, and will only revert to its first value upon a manual or other reset of the processor.

The state machine 235 transitions from the first state to the second state in response to a second control signal, e.g., the chip select (CS) signal, having a first value, e.g., 0. On a subsequent clock edge, the state machine 235 transitions from the second state to the third state provided the second control signal maintains its first value. If the first control signal reverts to its first value, or the second control signal transitions to a second value, e.g., 1, the state machine 235 will transition from the second state to the first state. Similarly, once in the third state, the state machine 235 will transition from the third state to the first state if the first control signal reverts to its first value, or the second control signal transitions to its second value. Other state machines or methods of generating the select signal may further be utilized. In general, the select signal should assume a value adapted to select the hardware strobe to refresh the watchdog device when it is desired to bypass the software output or a value adapted to select the software output as the refresh strobe when it is desired to utilize the software to refresh the watchdog device.

### CONCLUSION

Various embodiments have been described for choosing between a hardware strobe and a software output for refreshing a watchdog device. The embodiments of the invention allow the user to utilize software applications on their watchdog-controlled processor-based system regardless of whether the software applications are capable of producing a desirable refresh strobe.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A method of operating a watchdog device in a processor-based system, the method comprising:
selectively providing a hardware strobe to the watchdog device for refreshing the watchdog device during operation of a software application on the processor-based system.

2. The method of claim 1, wherein the selection to provide the hardware strobe is made in response to a select signal indicative of whether the software application normally generates a refresh strobe having a period known to be less than a timeout period of the watchdog device.

3. The method of claim 2, further comprising:
providing the refresh strobe of the software application to the watchdog device when the select signal is indicative of a software application normally generating a refresh strobe having a period known to be less than the timeout period of the watchdog device.

4. The method of claim 2, wherein:
the select signal having a first and second value is generated by a state machine responsive to a chip select signal having a first and second value and a reset signal having a first and second value;
the select signal transitions from its first value to its second value only when the reset signal has its second value and the chip select signal has its second value;
the select signal reverts back to its first value if either the reset signal or the chip select signal have their first values; and
the second value of the select signal is indicative of the software application normally generating a refresh strobe having a period known to be less than the time-out period of the watchdog device.

5. A method of operating a watchdog device, comprising:
receiving a first signal at a first input of a multiplexer;
receiving a second signal at a second input of the multiplexer;
selectively providing either the first signal or the second signal to an output of the multiplexer as a refresh strobe; and
providing the refresh strobe to the watchdog device.

6. The method of claim 5, further comprising receiving the first signal as a software output.

7. The method of claim 6, further comprising:
providing the first signal to the output of the multiplexer if the software output is adapted to produce the first signal having a period less than a time-out period of the watchdog device; and
otherwise providing the second signal to the output of the multiplexer.

8. The method of claim 7, wherein the second signal is a clock signal.

9. A method of operating a watchdog device, comprising:
receiving a software output at a first input of the multiplexer;
receiving a clock signal at a second input of a multiplexer, wherein the clock signal has a period less than a timeout period of the watchdog device;
selecting either the first or second input of the multiplexer as an output of the multiplexer; and
providing the output of the multiplexer to the watchdog device as a refresh strobe.

10. The method of claim 9, wherein selecting either the first or second input of the multiplexer is in response to a select signal indicative of whether the watchdog device is to be refreshed by the software output.

11. A method of operating a processor-based system, comprising:
providing a refresh strobe from a software application to a watchdog device during operation of the software application on the processor-based system if the software application is expected to generate a refresh strobe having a period of less than a timeout period of the watchdog device;
providing a hardware strobe to the watchdog device as a refresh strobe during operation of the software application on the processor-based system if the software application is not expected to generate a refresh strobe having a period of less than the timeout period of the watchdog device; and
resetting the processor if the watchdog device does not receive a refresh strobe prior to the expiration of its timeout period.

12. The method of claim 11, further comprising:
initiating a counter upon providing the hardware strobe to the watchdog device;
disabling the counter upon providing the refresh strobe from the software application to the watchdog device; and
resetting the processor if the counter reaches a predetermined value prior to being disabled.

13. The method of claim 12, wherein initiating the counter further comprises resetting the counter.

14. The method of claim 12, wherein disabling the counter further comprises resetting the counter.

15. An electronic system, comprising:
a processor;
a watchdog device having an input for receiving a refresh strobe and an output for resetting the processor in the event that the refresh strobe is not received prior to a time-out of the watchdog device; and
a multiplexer having an output coupled to the input of the watchdog device, having a first input coupled to receive an output of a software application operating on the processor and having a second input coupled to receive a clock signal;
wherein the multiplexer is responsive to a select signal to couple its output to either its first input or its second input for providing the refresh strobe.

16. The electronic system of claim 15, further comprising:
a state machine for providing the select signal;
wherein the state machine is responsive to a first control signal indicative of whether the software application is adapted to generate a refresh strobe having a period of less than the time-out of the watchdog device and a second control signal indicative of a desire to reset the electronic system;
wherein the state machine provides a select signal having a first value when the first control signal is indicative of a software application adapted to generate a refresh strobe having a period of less than the time-out of the watchdog device and when the second control signal does not indicate a desire to reset the electronic system;
wherein the state machine provides a select signal having a second value when the first control signal does not indicate a software application adapted to generate a refresh strobe having a period of less than the time-out of the watchdog device or when the second control signal indicates a desire to reset the electronic system;
wherein the multiplexer couples its first input to its output when the select signal has its first value; and
wherein the multiplexer couples its second input to its output when the select signal has its second value.

17. An electronic system, comprising:
a processor;
a watchdog device having an input for receiving a refresh strobe and an output for resetting the processor in the event that the refresh strobe is not received prior to a time-out of the watchdog device;
a multiplexer having an output coupled to the input of the watchdog device, having a first input coupled to receive an output of a software application operating on the processor and having a second input coupled to receive a clock signal, wherein the multiplexer is responsive to a select signal to couple its output to either its first input or its second input for providing the refresh strobe; and
a counter responsive to the select signal to initiate the counter when the second input of the multiplexer is to be coupled to the output of the multiplexer and to disable the counter when the first input of the multiplexer is to be coupled to the output of the multiplexer, wherein the counter is adapted to reset the processor if the counter exceeds a predetermined value prior to being disabled.

18. A method of operating a processor-based system, comprising:
receiving a software output as a first refresh strobe source;
receiving a hardware strobe as a second refresh strobe source;
selecting either the first or second refresh strobe source for generating a refresh strobe;
applying the refresh strobe to a watchdog device; and
resetting a processor of the system if the watchdog device reaches a timeout period prior to receiving the refresh strobe.

19. The method of claim 18, wherein the hardware strobe is a clock signal of the processor-based system.

20. The method of claim 19, wherein the first refresh strobe source is selected for generating the refresh strobe when a software application running on the processor produces the software output having a period of less than the timeout period of the watchdog device.

21. The method of claim 19, wherein the second refresh strobe source is selected for generating the refresh strobe when a software application running on the processor produces the software output having a period of greater than the timeout period of the watchdog device.

22. The method of claim 19, wherein the second refresh strobe source is selected for generating the refresh strobe when a software application running on the processor produces the software output having an unknown period.

23. The method of claim 19, wherein the second refresh strobe source is selected for generating the refresh strobe when a software application running on the processor produces the software output having no strobe.
